(19) United States
(12) Patent Application Publication
(10) Pub. No.: US 2003/0084104 A1
(43) Pub. Date: May 1, 2003

(54) System and method for remote storage and retrieval of data

(76) Inventors: Krimo Salem, Los Gatos, CA (US); Andrew Rowe, Los Gatos, CA (US); Ryan Yu, San Jose, CA (US); Ziad Chbeir, Croton-on-Hudson, NY (US)

Correspondence Address: GARY CARY WARE & FREIDENRICH LLP, 1755 EMBARCADERO ROAD, PALO ALTO, CA, 94303-3340, US

(21) Appl. No.: 10/001,514

(22) Filed: Oct. 31, 2001

(51) Int. Cl. G06F 15/16

(52) U.S. Cl. 709/205; 709/219

(57) ABSTRACT

The present invention enables mobile users to access documents and/or corporate resources in their native application (i.e., Microsoft Word, Microsoft Excel, Microsoft PowerPoint, etc.) from a remote hosting environment irrespective of the applications resident on the user's computer (i.e., a personal computer, PDA, cellular telephone, etc.). In an aspect, a usermay access a hosting environment on the Internet, and synchronize data between the user's personal computer and the hosting environment, thereby permitting subsequent unlimited access to documents and/or corporate resources using a web browser from any location. Preferably, the synchronization of the data may occur manually or automatically.

The present invention relates to computer systems, and more particularly, to a system and method that enables users to remotely store and retrieve data in a robust hosting environment for retrieval using a traditional WAN connection.

### BACKGROUND OF THE INVENTION

“Mobile users” are traditionally classified in the information technology industry as a workforce within a company who have limited access to network resources due to a variety of reasons related to their business activities. As a mobile user, the need to carry a portable computer, laptop or notebook, in order to access vital documents while out of the office or when logged off of a company's network is a necessity. Generally, the mobile user will access and work on particular documents locally, and later connect to their company's e-mail system and send documents to their co-workers and customers. Unfortunately, by enabling mobile users to have more freedom to work away from the office, information technology departments of such companies are faced with a myriad of support issues, such as the establishment of a secure connection between a mobile user's laptop and the company's network, and the loss of documents and data when a laptop hard drive fails, among others. The mobile user also faces a variety of support issues, such as the inability to dial access numbers from particular locations, and the inconvenience of transferring very large files via a low bandwidth connection to the network.

Existing solutions offer remote access to a corporate LAN or personal computer via a VPN connection. However, such access typically requires special software to securely access the corporate network. It would be useful to present a system which provides user's secure access to documents and corporate resources at any time from any location using their computer via a traditional Internet connection, to allow such users to retrieve the documents irrespective of the applications resident on the client's computer. It is to this end that the present invention is directed.

### SUMMARY OF THE INVENTION

The present invention enables mobile users to access documents and/or corporate resources in their native application (i.e., Microsoft Word, Microsoft Excel, Microsoft PowerPoint, etc.) from a remote hosting environment irrespective of the applications resident on the user's computer (i.e., a personal computer, PDA, cellular telephone, etc.). In an aspect, a user may access a hosting environment on the Internet, and synchronize data between the user's personal computer and the hosting environment, thereby permitting subsequent unlimited access to documents and/or corporate resources using a web browser from any location. Preferably, the synchronization of the data may occur manually or automatically.

In an aspect, the invention affords a data storage and retrieval system that comprises a hosting environment having one or more different applications running on one or more servers at the hosting environment that allows a remote computing device to access data stored at the hosting environment immaterial of whether a particular application for accessing the data is installed on the remote computing device.

In a specific embodiment of the invention, the hosting environment may include a first network that provides access to the data from a remote computing device, a second network that enables interface connectivity between the hosting environment and the remote computing device, a third network that manages and maintains the data at the hosting environment, and a fourth network that controls the operation of the different networks in the hosting environment.

The first network may include one or more terminal servers that provides access to the data stored at the hosting environment from a remote computing device. Additionally, the terminal servers may include a virtual desktop application that enables a remote computing device to access a virtual computing environment at the hosting environment and retrieve the data stored thereat. The terminal servers may further include a virtual server application that provides a communications interface amongst the networks in the hosting environment. Preferably, the first network is accessible via a virtual private network or is accessible directly via the Internet.

The second network may include one or more front-end servers for communicating with the remote computing device. The third network may include one or more file servers for storing the data at the hosting environment. Additionally, the third network may further include one or more mail servers for managing e-mail communication via the hosting environment. Preferably, the file severs are clustered, and the third network is accessible via a virtual private network. The mail server enables a globally accessible, secure messaging environment that can be accessed by the remote computing device. The fourth network includes one or more intranet servers that manages the remote accesses to the data stored at the hosting environment.

In another aspect, a data storage and retrieval system comprises a hosting environment having one or more different applications running on one or more servers at the hosting environment, wherein data from a remote computing device is stored at the hosting environment for subsequent retrieval of the data, such that synchronization of the data between the remote computing device and the hosting environment occurs at frequent intervals.

In another embodiment, the hosting environment may include one or more terminal servers that provides access to the data stored at the hosting environment from a remote computing device. The terminal servers may include a virtual desktop application that enables a remote computing device to access a virtual computing environment at the hosting environment and retrieve the data stored thereat. Preferably, the hosting environment is accessible directly via the Internet using a web browser application. The hosting environment may further include one or more file servers for storing the data at the hosting environment.

In still another aspect, a data storage and retrieval method comprises the steps of comparing each document on a computing device that is intended to be synchronized with the documents presently stored at a hosting environment to determine whether any of the documents stored on the remote computing device need to be replicated at the hosting environment. If a document on the computing device that is intended to be synchronized is not also stored at the hosting environment, the document is replicated at the hosting environment such that the same version of the document exists on the computing device and at the hosting environment. If a document on the computing device that is intended to be synchronized is stored at the hosting environment, but the data in the document stored on the computing device is different from the data in the document stored at the hosting environment, and the document stored on the computing device contains a more recent version of the data, the document is replicated at the hosting environment such that the same version of the document exists on the computing device and at the hosting environment. If a document on the computing device that is intended to be synchronized is stored at the hosting environment, but the data in the document stored at the hosting environment is different from the data in the document stored on the computing device, and the document stored at the hosting environment contains a more recent version of the data, the document is replicated on the computing device such that the same version of the document exists on the computing device and at the hosting environment. If a document on the computing device that is intended to be synchronized is not stored at the hosting environment, the document is replicated at the hosting environment such that the same version of the document exists on the computing device and at the hosting environment. If a document at the hosting environment no longer exists on the computing device, the document is deleted from the hosting environment. The documents between the computing device and the hosting environment are synchronized and a virtual desktop interface is provided for remotely accessing the documents stored at the hosting environment with the computing device by interacting with a virtual desktop workspace, whereby the documents can be remotely accessed regardless of whether the computing device includes an appropriate application for accessing the documents. The documents may include data files or file folders containing one or more data files therein.

### BRIEF DESCRIPTION OF THE DRAWINGS

FIG. 1 is a detailed diagram of an architecture of the invention;

FIG. 2 is a diagram illustrating a conventional computer that may be used to access the hosting environment;

FIG. 3A is a flow chart illustrating a synchronization operation of the invention;

FIG. 3B is another flow chart, illustrating in more detail the synchronization operation depicted in FIG. 3A;

FIG. 4 is a diagram illustrating the operational flow of a synchronization operation for synchronizing data between a user's computing device and the hosting environment of the invention;

FIG. 5 is a diagram illustrating the operational flow of the hosting environment where a user's documents are made available for retrieval upon the user logging onto the hosting environment; and

FIGS. 6A-6G are exemplary screen shots which illustrate a virtual desktop workspace feature of the hosting environment and illustrate a synchronization operation of the invention.

### DETAILED DESCRIPTION OF THE PREFERRED EMBODIMENT

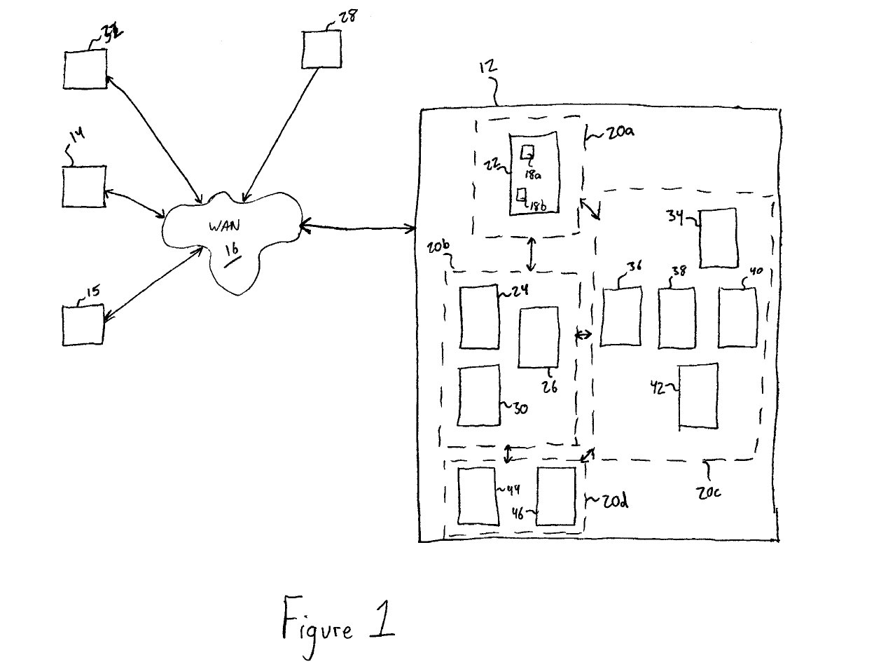

The present invention enables a user to access documents and/or corporate resources from a remote hosting environment in their native application environment. A company, for example, may choose to utilize the services of the hosting environment to allow its employees to synchronize their documents by uploading them to the hosting environment so that such documents are subsequently readily available to the employee(s) at any time. Using a traditional web browser application, for example, an employee (user) can access the Internet and log onto the hosting environment with a dedicated account and retrieve desired documents. FIG. 1 is a detailed diagram of an architecture of the invention which permits such.

As shown in FIG. 1, a hosting environment 12 may include one or more servers (to be described in detail below) that together allow a user (such as an employee of a company, for example) to remotely access the hosting environment 12 using the user's personal computer 14 (i.e., laptop/desktop, PDA/handheld, network workstation, etc.) and retrieve needed documents and/or company resources from the hosting environment 12. The personal computer 14 may access the hosting environment 12 across a wide area network (WAN) 16, such as the Internet, or more particularly, the World Wide Web.

The hosting environment 12 may be subdivided into subnets which may include one or more respective servers 18 which serve various functions of the hosting environment 12. For example, in an embodiment of the invention shown in FIG. 1, the hosting environment 12 may be subdivided into a virtual desktop subnet 20a that provides the availability of documents and/or corporate resources to a user remotely accessing the hosting environment 12, a front-end subnet 20b for providing the interface connectivity between the hosting environment 12 and the user's computing device 14, a back-end subnet 20c for managing and maintaining company and user-specific information, and an intranet subnet 20d for operating the intranet of the hosting environment 12. Other subnets may be utilized as desired.

The virtual desktop subnet 20a may include one or more terminal servers 22 that provide the remote availability of documents and/or corporate resources in accordance with the invention. Respective terminal servers 22 are preferably assigned and accessible to a particular company using the services of the hosting environment 12. For example, a company choosing to use the services of the hosting environment 12 may be assigned a cluster of four terminal servers 22 (the number is arbitrary) that only users affiliated with that company may access. The virtual desktop subnet 20a may be accessed, for example, via VPN or directly from the Internet 16. The terminal servers 22 communicate with the intranet subnet 20d (described below) via HTTPS protocols, and also communicate with file servers 34, mail servers 32, and the Active Directory on the back-end subnet 20c (described below).

The front-end subnet 20b may include one or more front-end servers 24 for communicating with client computing devices 14, such as personal computers and laptops, a WAP gateway 26 for communicating with wireless devices 28, and a PDA gateway 30 for communicating with PDA devices 32. Each of the severs in the front-end subnet 20b may be accessed without the use of VPN.

The back-end subnet 20c may include one or more database servers 34 for maintaining client and account information, a mail server 36 for managing e-mail communications via the hosting environment 12, a file server 38 for maintaining client-specific file data, a PKI server 40 to manage the public key infrastructure used to generate certificate keys for encryption, and a global catalog server 42 (a service and store that contains a replica of every object in the Active Directory). For hosted applications that require use of a database engine, the system preferably employs SQL 2000, however other database engines may be utilized without departing from the invention. Configuration to SQL may be defined on an application-by-application basis. Additionally, certain hosted applications may require workflow capabilities. For such hosted applications, preferably the system utilizes the capabilities of the mail server 36 (for example, Microsoft Exchange) to provide such functionality. File server(s) 38 are preferably clustered for redundancy purposes, and may include one or more 4-way processors, at least four gigabytes of memory with at least nine gigabytes of storage availability, and are capable of communicating at a bandwidth of 100 megabytes with the network interface, however variations do not restrict the scope of the invention. The back-end subnet 20c is preferably restricted for those servers that will be accessed over VPN.

The mail server 36 enables a secure messaging environment that is globally accessible and provides robust messaging, public folders, workflow scheduling, videoconferencing, public key infrastructure, and Kerberos (a secure method for authenticating a request for a service in a computer network). Additionally, the mail server 36 supports a “universal inbox” where users can receive voice and facsimile messages directed to their e-mail addresses. All messages can be accessed over a mail client, telephone, and/or a wireless device.

The back-end subnet 20c also preferably utilizes an Active Directory design (a centralized and standardized directory service that automates network management of user data, security, and distributed resources, and enables interoperation with other directories) such that the Active Directory is segregated into organizational units. Certain of these organizational units may have associated children (or sub-root) directories. In accordance with the invention, an organizational unit may be created for each company that registers its users for services using the hosting environment 12. For each user that is registered with the hosting environment 12, a directory listing may be created on a database server (not shown) for that user containing user permission information. Access to the directory by a user may be made through a generic server-independent name, for example using DFS. Further, user administration may be performed by designating particular persons in each registered company to serve as administrators, and who interact with the system using an administration software application.

In a specific embodiment of the invention, one such organizational unit is the services organizational unit which contains a master listing of the security groups that are used by users of the services offered by the hosting environment 12. Exemplary security groups may include AllUsers (contains a listing of all users that utilize the hosting environment), AllAdmins (contains a listing of users than have administrative permissions), AllMultiOrgAdmins (contains a listing of the multi-organizational groups for each company using the hosting environment), AllNormalUsers (contains a listing of all normal users for each company using the hosting environment), AllTPCUsers (contains a listing of all users that utilize the TravelingPC service), TPCGroup (contains a listing of permissions that are available over selected terminal servers), and AllIntranetUsers (contains a listing of all users that utilize the Intranet service).

Another organizational unit may be the front-end servers organizational unit which contains a listing of all the intranet servers that are accessed by users. Preferably, a server based group policy is created to permit the AllUsers security group to log onto the intranet servers locally.

Another organizational unit may be the terminal servers organizational unit which itself has a child organizational unit structure for every company using the services of the hosting environment 12. Preferably, the terminal servers organizational unit has a server based group policy to enforce machine level security policies on all terminal servers 22. Each child organizational unit also preferably has a server based group policy that permits the TPCGroup of that company to log onto the terminal servers 22 designated to that specific company, which maintains security by forbidding different companies' users from accessing the same terminal server 22.

In a specific embodiment of the invention, the fourth organizational unit may be the hosting organizational unit which is a parent-level organizational unit that contains a child-level organizational unit for each company using the services of the hosting environment 12. A user based group policy is preferably assigned to the hosting organizational unit to provide a secure computing environment, enforce the availability of applications, and to map a user's document folder to a file server 38 located in the back-end subnet 20b. Further, each child organizational unit contains all users' accounts and groups relevant to a company, may have additional user based group policies that define additional configurations, and allows each user to have a roaming profile uniquely configured and maintained on the file server 38 (the roaming profile is described in more detail below).

The intranet subnet 20d contains IIS servers that run and maintain the intranet, and may include an intranet server 44 contains intranet applications that manage role-based, end-user access to multiple applications and information sources, and a conferencing server 46 providing web-based conferencing and collaboration resources. The intranet subnet 20d may be accessed using a combination of VPN and direct access connections. Preferably, the intranet server(s) 44 are clustered (i.e., a two-way cluster, a four-way cluster, etc.), and may include one or more 8-way processors, at least 8 gigabytes of memory with at least 18 gigabytes of storage availability, and are capable of communicating at a bandwidth of at least 100 megabytes with the network infrastructure (alternative configurations are contemplated).

Each of the subnets 20a-d may be connected to the WAN 16 via a firewall (not shown) or other high security means. Preferably, the servers described above run the Windows 2000 operating environment, however, other operating environments may be used without departing from the invention. Additionally, while the above embodiment has been described with the hosting environment 12 subdivided into four subnets 20a-d, those skilled in the art recognize that the hosting environment 12 may be alternatively configured without departing from the invention, and that the above description is merely illustrative of an embodiment of the invention.

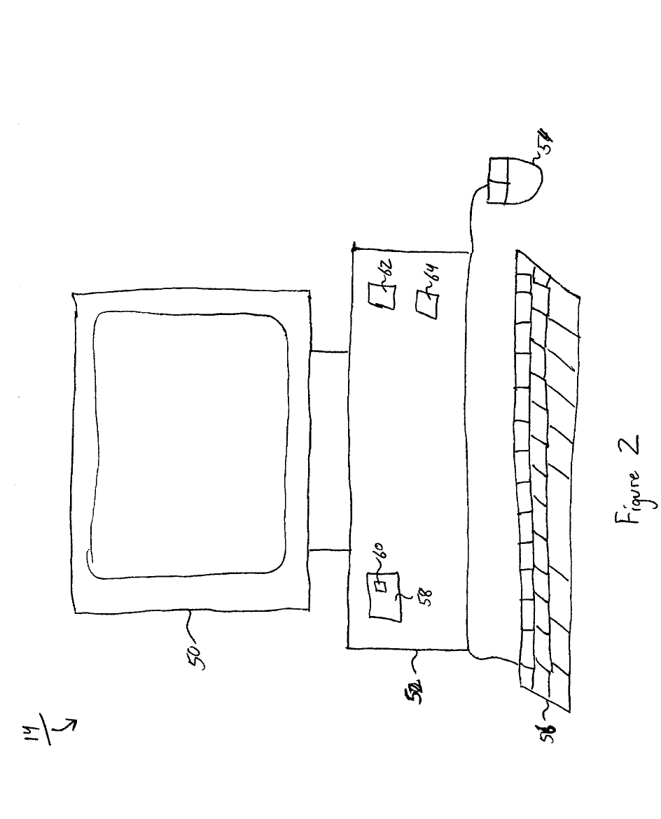

As described above, a user can remotely access the hosting environment 12 and retrieve documents and/or corporate resources. The user's personal computer 14 may be a workstation, desktop computer, laptop computer, PDA, or other similar computing system capable of accessing the Internet (alternatively, the user could also access the system via a wireless device, such as a cellular telephone that is capable of connecting to the Internet 16 via a wireless provider). A typical desktop personal computer 14, shown in FIG. 2, may include a display device 50, a chassis 52, and one or more user input devices, such as a mouse 54 and a keyboard 56. The chassis 52 may house a permanent storage system 58, such as a hard disk drive, optical disk drive, tape drive, or the like, which may store one or more software applications, such as a web browser application 60. The personal computer 14 may have a memory 62 resident therein and the software application from the disk 58 may be transferred to the memory 62 to be executed by a CPU 64 in the computer 14. The browser application 60 may be configured to connect the computer 14 to the hosting environment 12 over the WAN 16 and receive information that may be displayed on the display device 50 to the user. The browser application 60 may also permit the computer 14 to interact with the hosting environment 12 such as by retrieving documents and/or company resources from the servers. While a conventional desktop computer 14 has been described, those skilled in the art recognize that other computing devices utilize many of the same elements described above and, as such, need not be described herein in detail, however, the above description is not intended to be limiting and is merely for illustrative purposes.

The terminal server(s) 22 preferably include one or more software applications 18 to enable users to access documents and/or corporate resources. For example, the terminal server 22 may include a virtual desktop software application 18a that enables users to access a “virtual PC” on the server 22 to retrieve documents from the hosting environment 12. Preferably, the virtual desktop application 18a operates on a Windows 2000 server with terminal services configured for application mode, however, it may operate on other environments without departing from the invention. Server-side hosted applications (i.e., Microsoft Office, Microsoft Project, Adobe Illustrator, etc.) are preferably compatible with terminal server installation. Users may access data from the hosting environment 12 using, for example, the virtual desktop application 18a, direct mapping over a secure VPN connection, or via HTTPS. VDesktop is designed from the ground up to access and to protect data in desktops and mobile laptops without the need to access them directly. It delivers fast, non-intrusive access and back up services over any speed connection. It also provides unlimited access to documents and/or corporate resources using a conventional web browser application, independent of whether the user's computing device has installed thereon a particular application for using the selected document.

The terminal server 22 may also include a virtual server software application 18b that enables centralization of database applications and user documents. The virtual server application 18b preferably operates on a Windows 2000 server that is configured with SQL 2000 and Microsoft's Distributed File System to provide seamless access to user's data independent from the physical server, however, it too may operate on other environments without departing from the invention. The vServe application is designed to provide an interface between the front-end servers, application servers, and the data storage repository on the back-end servers. When a user accesses resources on the front-end or at the application server level, the vServe application will initiate a connection to a user's centrally located data storage location.

A user accessing the hosting environment 12 may log onto the Internet 16 by conventional means, with his or her personal computer 14. The personal computer 14 may run any of a number of different operating environments, such as Windows NT, Windows 2000, Windows XP, or other operating environment, and documents resident on the hosting environment 12 may be accessed remotely, irrespective of the applications resident on the client's computing device 14. To access the hosting environment 12 via the Internet 16, preferably, the browser application 34 is capable of executing ActiveX components or Java; however, other protocols may be used without departing from the invention.

The following describes a manner in which a user may remotely access the hosting environment 12 via the Internet 16. Those skilled in the art recognize that this description is for illustrative purposes and alternative methods may be used without departing from the invention. Assuming that a user wishes to access the hosting environment 12 via a network, for example, by using a laptop computer 14 that may be connected to the Internet 16 in the user's office, a session may be established between the user's computer 14 and the terminal server(s) 22 and a synchronization application (vSync) may be invoked to synchronize the user's documents on the computer 14 and the hosting environment 12. The vSync application provides the functionality to synchronize the user's local data (i.e., on the user's computing device 14) with the file server 38. Preferably, the vSync application is based on Java technology and does not require any configuration to be run on the user's computing device 14, and is launched from the user's browser application 60.

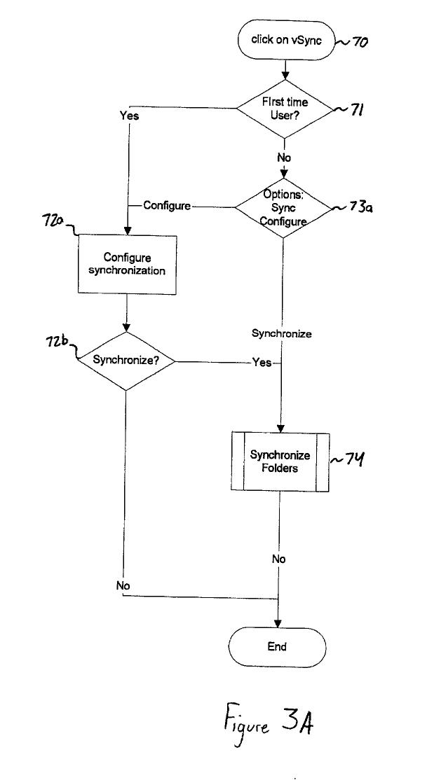

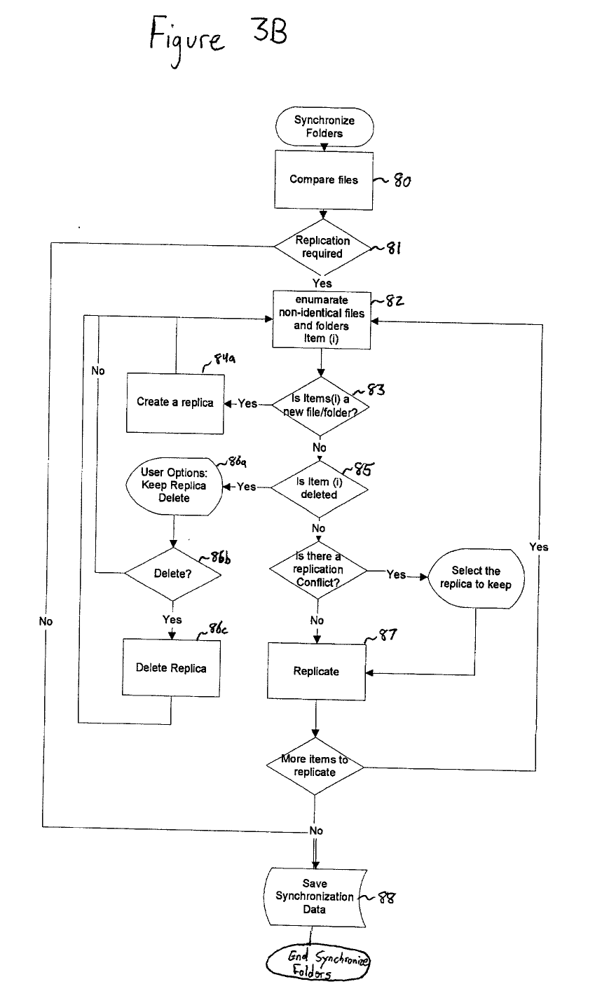

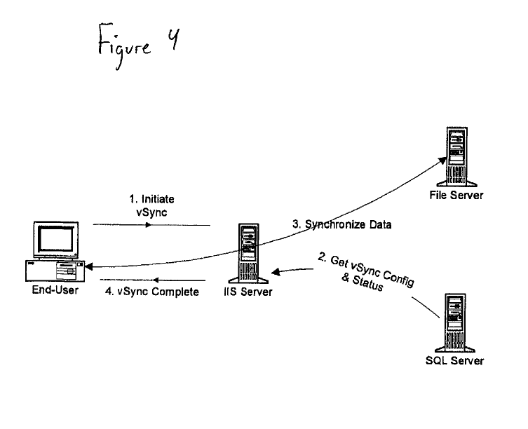

Preferably, the vSync application uses a secure encrypted communication protocol (i.e., SSL) to transmit data between the hosting environment 12 and the user's computing device 14. The vSync application is bi-directional allowing data to be transmitted from either direction. The flowchart shown in FIG. 3A depicts the operation of the vSync application. As shown, upon a user selecting to synchronize his or her documents with the hosting environment (Step 70), the application determines whether this is the user's first attempt to synchronize documents (Step 71). If so, the user is prompted to configure the synchronization application (Step 72a) to select a file folder in which to maintain the documents to be synchronized, and then the user is prompted to synchronize the documents (Step 72b). If the user has synchronized documents previously, the system prompts the user whether he or she wishes to modify the configuration of the application (Step 73a). The synchronization application initiates the synchronization operation and updates the necessary documents accordingly (Step 74).

FIG. 3B illustrates the detailed methodology of the synchronization application in synchronizing applications between the user's computing device 14 and the hosting environment 12. Initially, the documents to be synchronized are compared (Step 80), and the application determines whether replication of the document is required (Step 81). If not, then the application saves the synchronization data (Step 88) and the application terminates. Otherwise, non-identical files and folder items are enumerated (Step 82) and the application checks whether each file and folder are new (Step 83). If the file or folder is new, a replica is created (Step 84a). Otherwise, the system checks whether the item or folder has been deleted (Step 85), and deletes the replica as appropriate (Steps 86a-c). If the file or folder is not new, and has not been deleted, then the application replicates the changed document and/or folder to be synchronized (Step 87), saves the synchronization data (Step 88), and the application terminates.

Once the user's documents have been synchronized with the hosting environment 12, the user can effectively work with those documents on either environment (hosting environment 12 or native computing device 14) at any time. Documents may be synchronized at any time, at the will of the user, and synchronization may be configured to occur on a predetermined schedule throughout the day, such that backup copies of the documents may be automatically transmitted to the hosting environment 12 at various times during the day.

The following describes a manner in which a user may gain access to the hosting environment 12 from a mobile laptop. As described above, initially, a user may synchronize documents using the vSync application. Once the user's documents have been synchronized between the mobile laptop and the hosting environment 12, the user will be able to work in either environment (hosting environment 12 or native computing device 14) at any time. To access the hosting environment 12 from a remote location, the user may access the Internet 16 via his or her browser application 60 and may log onto the internet domain associated with the hosting environment 12 via the user's browser application 60 using HTTPS protocols, to ensure a secure connection with an encrypted terminal server session. When the user attempts to log onto the hosting environment 12, the user's request may be handled by a cluster of servers that preferably run the Windows Terminal Server application. Optimization technologies ensure that the user's connection is routed to the “least busy” server. Server clustering allows for redundancy in case of a failure of one of the servers. For example, in the event that one of the servers has a hardware or software failure, a user can reestablish his or her connection on a subsequent login to a different server.

To log onto the hosting environment 12, the user may transmit a valid login credential (i.e., user name) and password. Upon successful login, a roaming profile is activated for that user. The roaming profile allows users to establish back end connectivity to data sources, documents, and user data regardless of which terminal server 22 the user logs onto. The roaming profile also allows users to customize the workspace and applications used. Preferably, within the hosting environment 12, the user is presented with a standardized terminal session, with all subscribed applications and personal documents available to the user. The user's synchronized documents are available for retrieving under a centralized location. Additionally, the user's e-mail may also be accessible via the mail server 32.

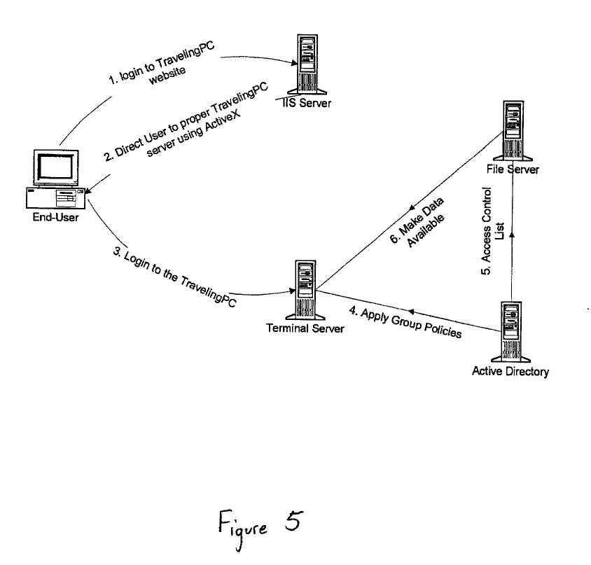

FIG. 5 is a diagram showing the data flow within the system when a user synchronizes applications between the computing device 14 and the hosting environment 12. As shown in FIG. 5, initially, the user initiates the vSync application that is resident on the user's computing device 14 as described above. A vSync request message is received by the hosting environment 12 which retrieves vSync configuration and status information from one of the database servers 34 in the hosting environment 12 and initiates the synchronization of data between the file server 38 and the user's computing device 14. After all data has been synchronized, the hosting environment transmits a vSync complete message to the user's computing device 14 and the vSync application is terminated.

Once the user's documents have been synchronized with the hosting environment 12, the user may subsequently access those documents remotely by logging onto the hosting environment 12 and retrieving the documents. FIG. 5 is a diagram illustrating this methodology. Initially, a user desiring to retrieve documents from the hosting environment 12 logs onto a website associated with the hosting environment 12 via the user's web browser application 60. A logon request message is received by the hosting environment 12 and the user is connected with the proper terminal server 22 which enables the user to log onto the hosting environment 12 and retrieve any documents. Once a log on attempt has been made and is successful, the appropriate group policies (as described above) are applied, a control listing of the user's data is accessed at the file server 38, and the user's documents are made available for retrieval.

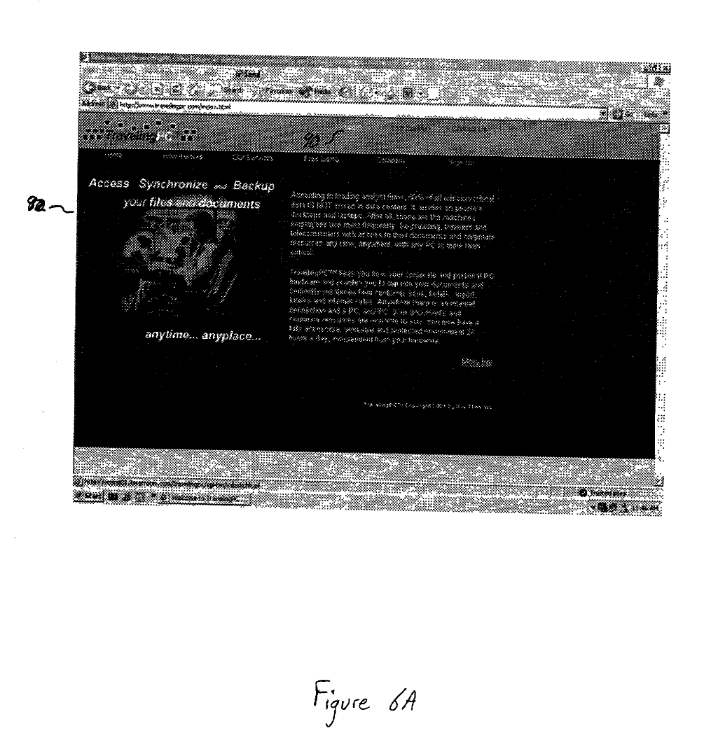

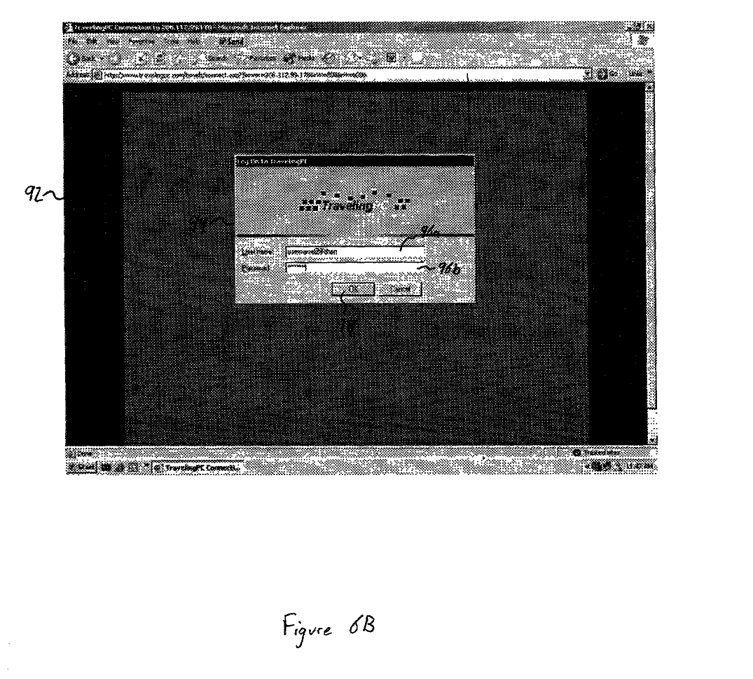

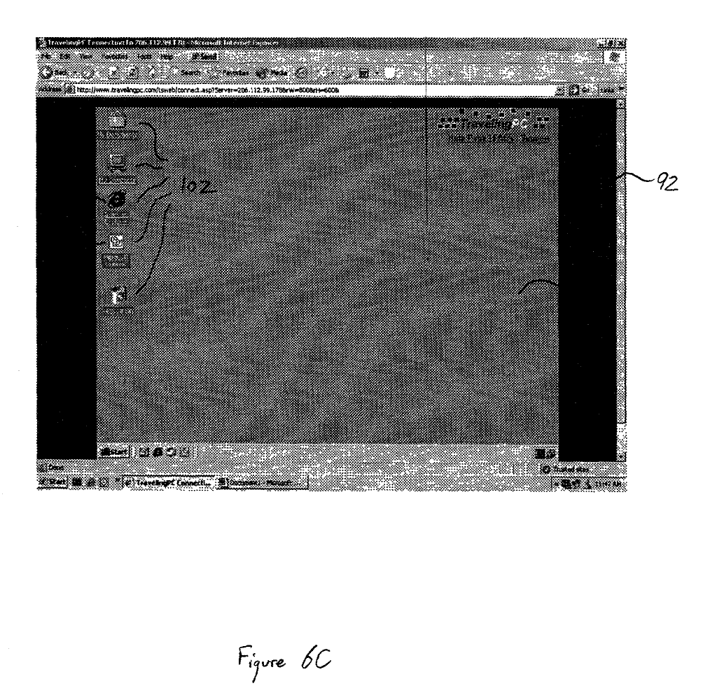

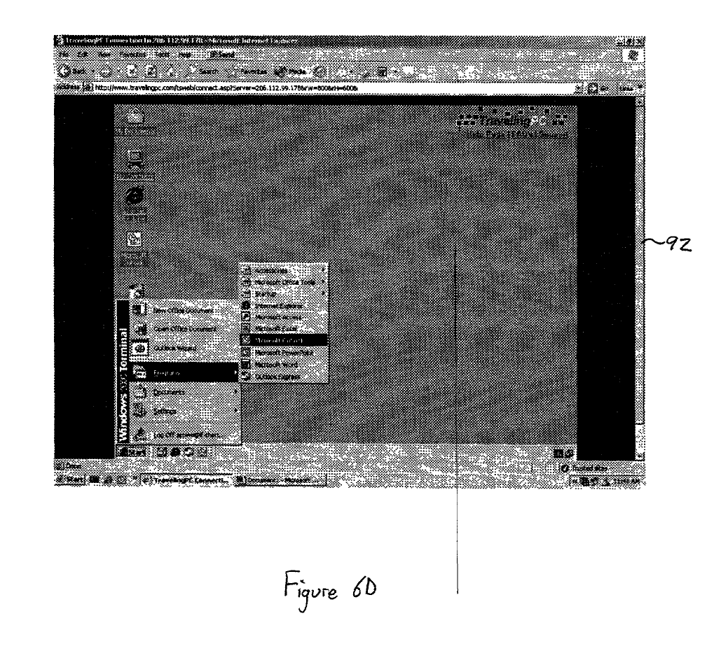

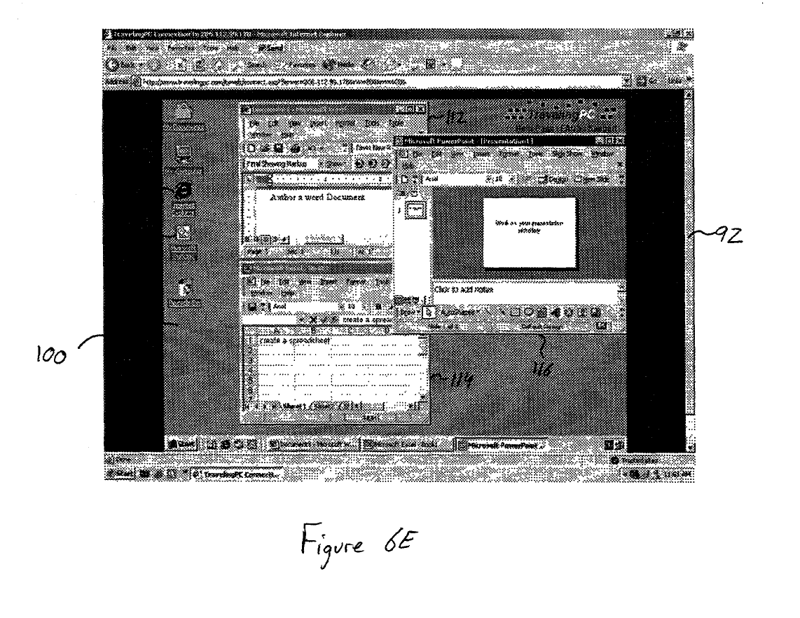

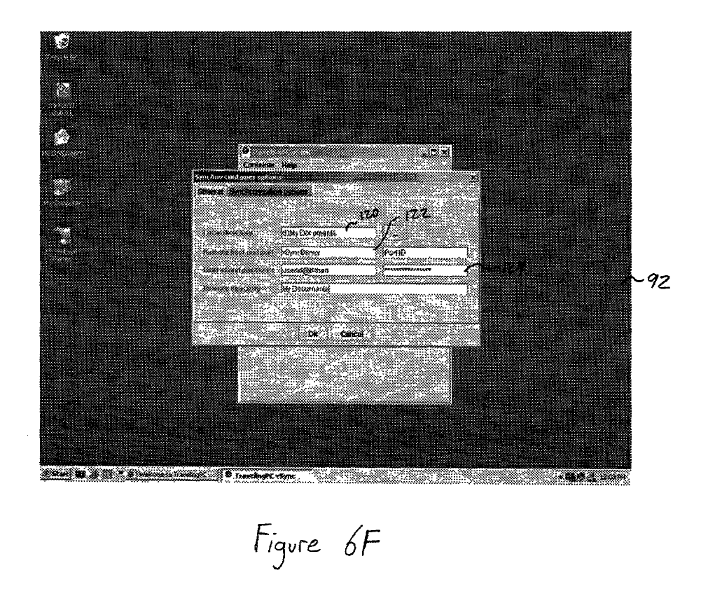

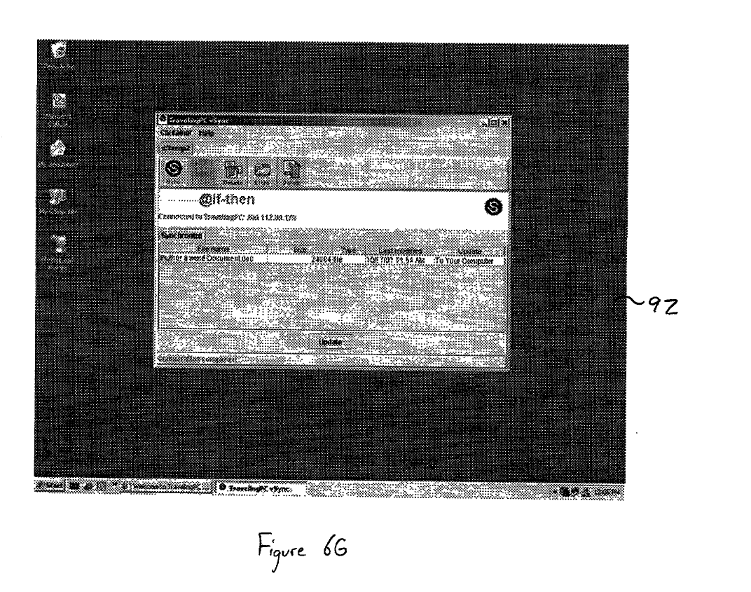

FIGS. 6A-6G are exemplary screen shots which further illustrate the operational flow of the invention. In FIG. 6A, a user wishing to log onto the hosting environment 12 access a website associated with the hosting environment 12 via the user's web browser application 60 and selects a login prompt 90 at the top of the displayed webpage 92. Upon selecting the login prompt 90, the user may be presented with a dialog box 94 (FIG. 6B) requesting the user to enter a valid username (data entry box 96a) and password (data entry box 96b). The user enters the requested information and selects the “OK” button 98 to transmit the username and password data to the hosting environment 12.

Once the user is authenticated to the hosting environment 12, the user is given full access to a virtual desktop workspace 100 via the user's web browser application 60. Note that in FIG. 6C, the virtual desktop workspace 100 includes various icons 102 for hosted applications that are available to the user. For example, via the virtual desktop workspace 100, the user may access a hosted Internet Explorer internet application 102a, and a hosted Microsoft Outlook e-mail application 102b. Additionally, from the virtual desktop workspace 100, users have access to a variety of other applications, including some applications that the user may not have installed on his or her native computer environment. In FIG. 6D, the various hosted applications that a user may utilize are those available from Microsoft Office XP, however, the variety and/or type of applications is limitless. Other applications and company-specific client server applications can also be installed, configured, and hosted by the hosting environment 12 and made available to a user.

FIG. 6E illustrates a virtual desktop workspace 100 in which a user is creating and/or accessing a Microsoft Word document 110, a Microsoft Excel spreadsheet 112, and a Microsoft PowerPoint presentation 114, using the hosted applications available to the user via the hosting environment 12. Again, the user can utilize these applications whether or not the user's own computing device 14 includes installed versions of these applications. When a user desires to save the documents accessed via the virtual desktop workspace 100, the user saves the document(s) to the preconfigured system folder on the virtual desktop workspace 100 (such as the “My Documents” folder).

When the user returns to his or her native desktop on his or her computing device 14, the user is able to access any of his or her documents via the vSync application. FIG. 6F is a screenshot illustrating sample configuration parameters of the vSync application, including local directory information 120 for maintaining the files to be synchronized with the hosting environment 12, server configuration information 122, and username and password information 124. Once the vSync application scans both the user's local computing device 14 and the hosting environment 12 for the same file names, the differences between the files are displayed to the user and he or she is given a choice of action (i.e., whether to update the file with the changes, or delete the file). This is shown in the exemplary screen shot of FIG. 5G. Whether the user chooses to update the file or delete the file, after processing the user's request, the synchronization process completes and documents that were not deleted reside both on the user's computer 14 and on the hosting environment 12 for subsequent retrieval.

While the above has been described with reference to a particular system for enabling remote access and synchronization of documents, those skilled in the art will recognize that other techniques may be used without departing from the invention.

What is claimed is:

1. A data storage and retrieval system, comprising:
a hosting environment having one or more different applications running on one or more servers at the hosting environment that allows a remote computing device to access data stored at the hosting environment immaterial of whether a particular application for accessing the data is installed on the remote computing device.

2. The data storage and retrieval system of claim 1, wherein the hosting environment includes a first network that provides access to the data from a remote computing device, a second network that enables interface connectivity between the hosting environment and the remote computing device, a third network that manages and maintains the data at the hosting environment, and a fourth network that controls the operation of the different networks in the hosting environment.

3. The data storage and retrieval system of claim 2, wherein the first network includes one or more terminal servers that provides access to the data stored at the hosting environment from a remote computing device.

4. The data storage and retrieval system of claim 3, wherein the terminal servers include a virtual desktop application that enables a remote computing device to access a virtual computing environment at the hosting environment and retrieve the data stored thereat.

5. The data storage and retrieval system of claim 4, wherein the terminal servers further include a virtual server application that provides a communications interface amongst the networks in the hosting environment.

6. The data storage and retrieval system of claim 3, wherein the first network is accessible via a virtual private network.

7. The data storage and retrieval system of claim 3, wherein the first network is accessible directly via the Internet.

8. The data storage and retrieval system of claim 2, wherein the second network includes one or more front-end servers for communicating with the remote computing device.

9. The data storage and retrieval system of claim 2, wherein the third network includes one or more file servers for storing the data at the hosting environment.

10. The data storage and retrieval system of claim 9, wherein the third network further includes one or more mail servers for managing e-mail communication via the hosting environment.

11. The data storage and retrieval system of claim 9, wherein the file severs are clustered.

12. The data storage and retrieval system of claim 9, wherein the third network is accessible via a virtual private network.

13. The data storage and retrieval system of claim 10, wherein the mail server enables a globally accessible, secure messaging environment that can be accessed by the remote computing device.

14. The data storage and retrieval system of claim 2, wherein the fourth network includes one or more intranet servers that manages the remote accesses to the data stored at the hosting environment.

15. The data storage and retrieval system of claim 1, wherein the computing device is a personal computer.

16. The data storage and retrieval system of claim 1, wherein the computing device is a personal data assistant (PDA) device.

17. The data storage and retrieval system of claim 1, wherein the computing device includes a web browser application for accessing the data stored at the hosting environment.

18. The data storage and retrieval system of claim 1, wherein the data is synchronized between the computing device and the hosting environment.

19. The data storage and retrieval system of claim 18, wherein the synchronization of the data occurs automatically.

20. A data storage and retrieval system, comprising:
a hosting environment having one or more different applications running on one or more servers at the hosting environment, wherein data from a remote computing device is stored at the hosting environment for subsequent retrieval of the data, such that synchronization of the data between the remote computing device and the hosting environment occurs at frequent intervals.

21. The data storage and retrieval system of claim 20, wherein the hosting environment includes one or more terminal servers that provides access to the data stored at the hosting environment from a remote computing device.

22. The data storage and retrieval system of claim 21, wherein the terminal servers include a virtual desktop application that enables a remote computing device to access a virtual computing environment at the hosting environment and retrieve the data stored thereat.

23. The data storage and retrieval system of claim 20, wherein the hosting environment is accessible directly via the Internet using a web browser application.

24. The data storage and retrieval system of claim 21, wherein the hosting environment further includes one or more file servers for storing the data at the hosting environment.

25. The data storage and retrieval system of claim 24, wherein the file severs are clustered.

26. The data storage and retrieval system of claim 20, wherein the computing device is a personal computer.

27. The data storage and retrieval system of claim 20, wherein the computing device is a personal data assistant (PDA) device.

28. A data storage and retrieval method, comprising the steps of:
comparing each document on a computing device that is intended to be synchronized with the documents presently stored at a hosting environment to determine whether any of the documents stored on the remote computing device need to be replicated at the hosting environment;
if a document on the computing device that is intended to be synchronized is not also stored at the hosting environment, replicating the document at the hosting environment such that the same version of the document exists on the computing device and at the hosting environment;
if a document on the computing device that is intended to be synchronized is stored at the hosting environment, but the data in the document stored on the computing device is different from the data in the document stored at the hosting environment, and the document stored on the computing device contains a more recent version of the data, replicating the document at the hosting environment such that the same version of the document exists on the computing device and at the hosting environment;
if a document on the computing device that is intended to be synchronized is stored at the hosting environment, but the data in the document stored at the hosting environment is different from the data in the document stored on the computing device, and the document stored at the hosting environment contains a more recent version of the data, replicating the document on the computing device such that the same version of the document exists on the computing device and at the hosting environment;
if a document on the computing device that is intended to be synchronized is not stored at the hosting environment, replicating the document at the hosting environment such that the same version of the document exists on the computing device and at the hosting environment;
if a document at the hosting environment no longer exists on the computing device, deleting the document from the hosting environment;
synchronizing the documents between the computing device and the hosting environment; and
providing a virtual desktop interface for remotely accessing the documents stored at the hosting environment with the computing device by interacting with a virtual desktop workspace, whereby the documents can be remotely accessed regardless of whether the computing device includes an appropriate application for accessing the documents.

29. The method of claim 28, wherein the documents include any of data files or file folders containing one or more data files therein.

30. The method of claim 28, wherein synchronization occurs automatically in accordance with a predetermined time schedule.

31. The method of claim 28, wherein the computing device includes any of a personal computer, a personal data assistant (PDA) device, and a cellular telephone.
